(19) United States
(12) Patent Application Publication
(10) Pub. No.: US 2012/0136467 A1
(43) Pub. Date: May 31, 2012

(54) INSULIN PUMP WITH VOICE MESSAGE CAPABILITY

(76) Inventor: Tawania M. Jackson, Florissant, MO (US)

(21) Appl. No.: 13/306,726

(22) Filed: Nov. 29, 2011

Related U.S. Application Data
(60) Provisional application No. 61/417,713, filed on Nov. 29, 2010.

(51) Int. Cl. G06F 17/00

(52) U.S. Cl. 700/94

(57) ABSTRACT

An insulin pump with voice message capability including a controller having a processor and memory, a voice recording system having a microphone, digital sampler and digital storage and a voice playback system having an audio amplifier and a speaker. The pump has a user interface configured to supply the controller with control inputs and a measurement system electrically coupled to an insulin pump measurement system. The controller is operatively coupled to the voice recording system, the voice playback system and the measurement system. The controller directs the measurement system to transmit a test measurement to the controller, which transmits the test measurement to the voice playback system and the voice playback system plays a prerecorded message corresponding to the test measurement. In an embodiment, the voice recording and playback system is replaced with a braille display.

### CROSS REFERENCE TO RELATED APPLICATIONS

This application claims the benefit of Provisional Application No. 61/417,713 filed on Nov. 29, 2011, which is incorporated herein by reference.

### BACKGROUND

1. Field of the invention

The present invention relates to insulin pumps having voice message capability for use by the visually impaired.

2.. Description of the Related Art

A large portion of the world's population is diagnosed with Diabetes Type 1. Unfortunately complications of diabetes can lead to visual impairment or blindness. Many people utilize insulin pumps to regulate their blood glucose level. The insulin pump is an alternative to single injections of insulin. The insulin pump provides intermittent insulin administration to the user and is a medical diagnostic testing device which is used to determine blood glucose level. However, insulin pumps usually use a series of “beeps” to indicate to the user that the testing process has concluded. Those insulin pumps that have a display screen still require that the individual view the screen to read blood glucose level. The solution offered by the invention is to offer a voice message capability when retrieving various blood glucose test results. The voice message system will annunciate the glucose test results, predictive alerts of high and low blood sugars and the amount of insulin administered. The predictive alerts will allow the individual to take action faster and ultimately gain better control of the blood sugar. The annunciation of how much insulin is administered can be bolus or temporary basal rate. The administration of a bolus dose of insulin is indicated for an abnormal high blood sugar. The temporary basal rate administration of insulin is indicated with instances such as, exercise, activities, or illness. The individual will have a choice of preferred language to select from. Language choices will be English, Spanish, French, Chinese, Aerobic, Russian, and Bosnian. All of the menu buttons will be recognized with brail and script writing.

The brail will assist the visually impaired with reading and understanding the menu and functions for the insulin pump that can annunciate the test result to the visually impaired or professional. The voice message capability can beneficially allow the sight impaired user information that relates to blood glucose test results. Thus, when the medical diagnostic testing device retrieves a test result, the user will hear a message such as “Apr. 24, 2002, 3:23 P.M.; glucose level is 104”. Such voice message capability can provide a more consistently normal level of blood glucose, which reduces the risk and cost of complications from diabetes.

### SUMMARY

In the exemplary embodiment the voice message and other functions are controlled by a menu-driven application program that is stored on a chip. The application program is parameter-driven in that the steps executed, and therefore, the message enunciated, by the various application programs depend on the button depressed by the user. For example, depressing and holding function button A for 2 seconds allows access to the medical diagnostic testing menu, or depressing and holding function button B for 2 seconds allows access to information about the user and the processor (chip) testing menus. See FIG. 3A for function button A logic, and FIG. 3B for function button B flow logic.

### BRIEF DESCRIPTION OF THE DRAWINGS

FIG. 2 is a block diagram for a medical device having voice message capability.

FIG. 3A is a flow diagram for button “A” logic, for a medical device having voice message capability.

FIG. 3B is a flow diagram for button “B” logic, for a medical device having voice message capability.

### DETAILED DESCRIPTION OF EXEMPLARY EMBODIMENTS

The solution offered by the invention is to offer a voice message capability when retrieving various blood glucose test results. The voice message system will annunciate the glucose test results, predictive alerts of high and low blood sugars and the amount of insulin administered. The predictive alerts will allow the individual to take action faster and ultimately gain better control of the blood sugar. The annunciation of how much insulin is administered can be bolus or temporary basal rate. The administration of a bolus dose of insulin is indicated for an abnormal high blood sugar. The temporary basal rate administration of insulin is indicated with instances such as, exercise, activities, or illness. The individual will have a choice of preferred language to select from. Language choices will be English, Spanish, French, Chinese, Aerobic, Russian, and Bosnian. All of the menu buttons will be recognized with brail and script writing. The brail will assist the visually impaired with reading and understanding the menu and functions for the insulin pump that can annunciate the test result to the visually impaired or professional. The voice message capability can beneficially allow the sight impaired user information that relates to blood glucose test results. Thus, when the medical diagnostic testing device retrieves a test result, the user will hear a message such as “Apr. 24, 2002, 3:23 P.M.; glucose level is 104”. Such voice message capability can provide a more consistently normal level of blood glucose, which reduces the risk and cost of complications from diabetes.

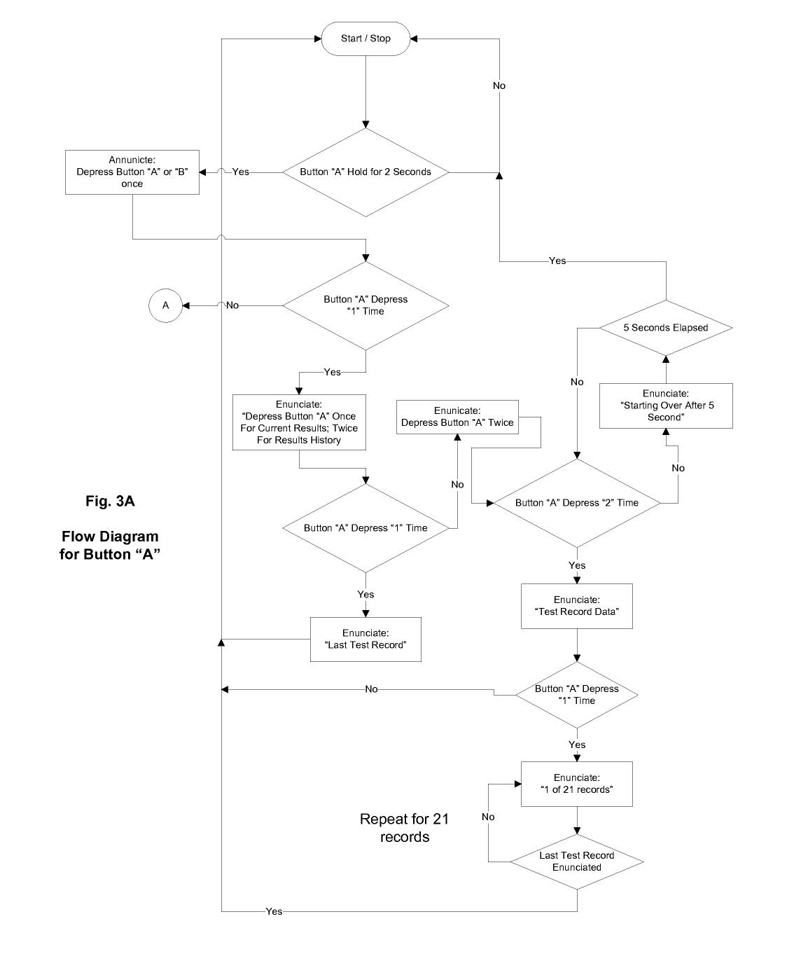

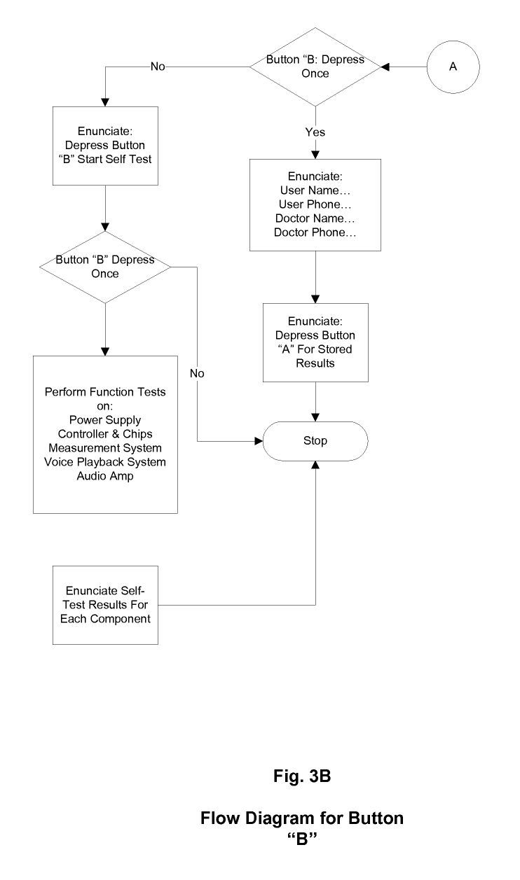

In the exemplary embodiment the voice message and other functions are controlled by a menu-driven application program that is stored on a chip. The application program is parameter-driven in that the steps executed, and therefore, the message enunciated, by the various application programs depend on the button depressed by the user. For example, depressing and holding function button A for 2 seconds allows access to the medical diagnostic testing menu, or depressing and holding function button B for 2 seconds allows access to information about the user and the processor (chip) testing menus. See FIG. 3A for function button A logic, and FIG. 3B for function button B flow logic.

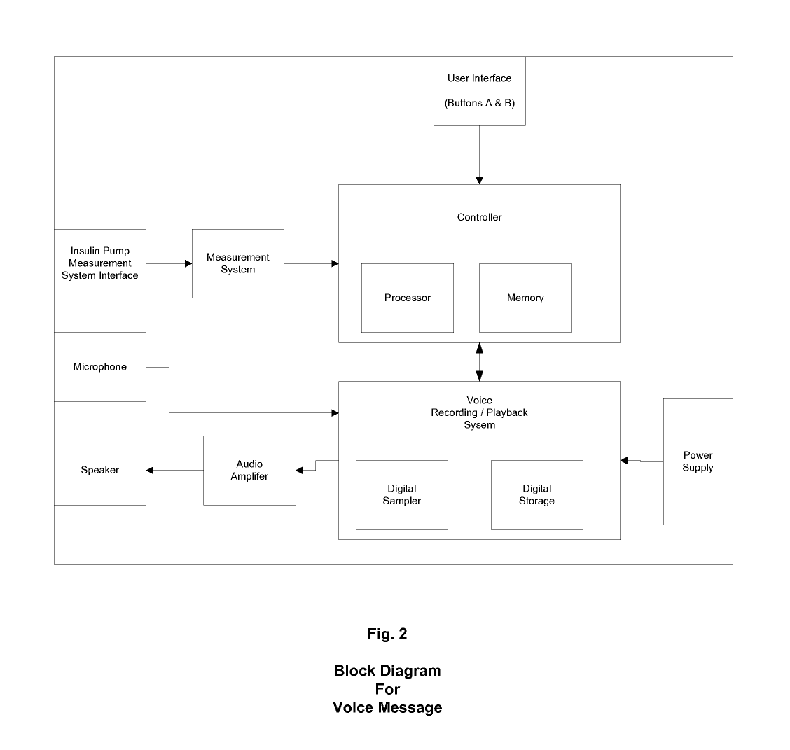

FIG. 2 is a block diagram of the exemplary embodiment with voice message capability. A measurement system (01) may interface with the existing insulin injection (not shown) to capture and store diagnostic test results. Measurement system (01) may, in turn, be coupled to a controller (02). In addition to controlling the measurement system (01) the controller may control the functioning of the processor (03), memory (04), user interface (05), recording/playback system (06), audio amplifier (07), digital storage (08) and sampler (09) devices, and transducers and digital-to-analog devices; all based on instructions from the controller.

The controller will include both a processor (03) and memory (04). Memory will store data (test records and the associated message to be annunciated) and machine language instructions that are executed by the processor (03) to control the functioning of controller (02).

The controller (02) will store blood glucose level test results in memory (04). The stored data is called a “test record”. A “test record” consists of the measured glucose level, time and date, and any other associated voice message(s). The test record can be selectively retrieved and enunciated at a later time. The retrieval process begins when the user or professional presses a series of buttons.

To enable voice message capability the exemplary embodiment includes a voice recording/playback system (06) for recording messages and playing back previously recorded instructions. Therefore, the voice system (06) may be coupled to a microphone (10) and speaker system (11) via an audio amplifier (07) for playing back messages and instructions. These operations are controlled by the controller (02).

In an exemplary embodiment, voice recording/playback system (06) will store data digitally. Therefore, a digital sampler is required for converting analog data to digital. In an exemplary embodiment the voice recording/playback system (06) may be provided as an integrated circuit.

In an exemplary embodiment the power supply includes one or more batteries and a voltage regulator. It is also understood that the power supply not only provides power for the voice system (06), also all other components.

As indicated, the controller (02) controls voice recording/playback system (06) in response to depression of the appropriate buttons; “A” or “B”. The beginning, end/duration of the test record message may be defined in various ways. For example, each message is allowed to run for a pre-determined time.

Preferred embodiments of the present invention are described above. Those skilled in the art will understand that changes and modifications may be required without departing from the true scope and intent of the invention.

I claim:

1. An insulin pump with voice message capability comprising:
a controller having a processor and memory;
a voice recording system having a microphone, digital sampler and digital storage;
a voice playback system having an audio amplifier and a speaker;
a user interface configured to supply the controller with control inputs;
a measurement system electrically coupled to an insulin pump measurement system;
the controller operatively coupled to the voice recording system, the voice playback system and the measurement system;
wherein the controller directs the measurement system to transmit a test measurement to the controller, the test measurement transmitted by the controller to the voice playback system and the voice playback system plays a prerecorded message corresponding to the test measurement.

2. The insulin pump of claim 1 wherein the controller is suitably programed chip to direct the measurement system to transmit a test measurement to the controller to instruct the voice playback system to play a prerecorded message corresponding to the test measurement.

3. An insulin pump with voice message capability comprising:
a controller having a processor and memory;
an output device;
a user interface configured to supply the controller with control inputs;
a measurement system electrically coupled to an insulin pump measurement system;
the controller operatively coupled to the voice recording system, the voice playback system and the measurement system;
wherein the controller directs the measurement system to transmit a test measurement to the controller, the test measurement transmitted by the controller to the output device and the output device configured to produce an output corresponding to the test measurement.

4. The insulin pump of claim 3 wherein the output produced by the output device is in braille.
